(19) United States
(12) Patent Application Publication
(10) Pub. No.: US 2022/0147537 A1
(43) Pub. Date: May 12, 2022

(54) DATA ANALYSIS DEVICE, DATA ANALYSIS METHOD, AND DATA ANALYSIS PROGRAM

(71) Applicant: NIPPON TELEGRAPH AND TELEPHONE CORPORATION, Tokyo (JP)

(72) Inventors: Yasutoshi IDA, Musashino-shi, Tokyo (JP); Yasuhiro FUJIWARA, Musashino-shi, Tokyo (JP)

(73) Assignee: NIPPON TELEGRAPH AND TELEPHONE CORPORATION, Tokyo (JP)

(21) Appl. No.: 17/438,475

(22) PCT Filed: Mar. 26, 2020
(86) PCT No.: PCT/JP2020/013688

§ 371 Date: Sep. 13, 2021

(30) Foreign Application Priority Data
Apr. 11, 2019 (JP) 2019-075952

(51) Int. Cl. G06F 16/25

(52) U.S. Cl. CPC G06F 16/254

(57) ABSTRACT

A data analysis device (10) is a data analysis device that extracts groups of important features from multidimensional data by using Sparse Group Lasso, and includes: a matrix norm computation unit (11) that computes a norm of a Gram matrix of given data; a score computation unit (12) that computes a score for a computation-target group among the groups of the data based on the norm; an omission determination unit (13) that determines whether or not to omit computation for the computation-target group based on the score; and a solver application unit (14) that applies, to the computation-target group, computation processing of Block Coordinate Descent used in Sparse Group Lasso in solving an optimization problem, when the omission determination unit (13) determines not to omit the computation for the computation-target group.

### TECHNICAL FIELD

The present invention relates to a data analysis device, a data analysis method, and a data analysis program.

### BACKGROUND ART

Feature extraction is a group of methods for extracting important features from data, and broadly used for describing data in data mining. In data mining, features of data frequently have a group structure.

For example, regionalized weather data is considered as data in which regions corresponds to respective groups, and each group has features such as “temperature”, “humidity”, “weather”, “wind direction”, and the like. With the data having such a group structure, important features may not simply be extracted but a group (for example, a group corresponding to a region) of important features may be extracted to describe the data in some cases. “Sparse Group Lasso” is a typical method for such extraction of a group of features.

Sparse Group Lasso is a method based on linear regression (for example, see Non-Patent Literature 1). Specifically, Sparse Group Lasso can handle the group features by applying group constraint on coefficients of a linear regression model. In Sparse Group Lasso, “Block Coordinate Descent” is used as standard in learning coefficients of linear regression models.

Block Coordinate Descent is an algorithm that independently updates and learns the coefficients of Sparse Group Lasso by each group. Computation of such update can be roughly divided into the following two steps.

A first step is a step that checks whether or not coefficients within a group all become zero. A second step is a step that updates the coefficients within the group when all of the coefficients within the group do not become zero.

With Block Coordinate Descent, the first step and the second step are repeated until all of the coefficients converge. The group in which the coefficients become zero at last is a group of unimportant features, and the group in which coefficients become nonzero is considered to be a group of important features.

However, with Block Coordinate Descent, there is a problem that the computation takes time for a large-scale data. This is because a computation order proportional to the number of entire features is required in the computation of the first step. As a result, it becomes difficult to apply Sparse Group Lasso to large-scale data.

Note here that a method called safe screening (see Non-Patent Literature 2) is broadly used for applying Sparse Group Lasso to large-scale data. Safe screening is a method that specifies and deletes the group in which the coefficients become zero, before learning the coefficients with Block Coordinate Descent.

### CITATION LIST

### Non-Patent Literature

Non-Patent Literature 1: N. Simon, J. Friedman, T. Hastie, and R. Tibshirani, “A Sparse-Group Lasso”, Journal of Computational and Graphical Statistics, 22(2), 231-245, 2013.
Non-Patent Literature 2: E. Ndiaye, O. Fercoq, A. Gramfort, and J. Salmon, “Gap Safe Screening Rules for Sparse-Group Lasso”, In Advances in Neural Information Processing Systems, pp. 388-396, 2016.

### SUMMARY OF THE INVENTION

### Technical Problem

However, with safe screening, Block Coordinate Descent is not sped up if the number of groups that can be deleted is small. Especially, it is theoretically known with safe screening that the group is hard to be deleted when initial values of the coefficients are far from the optimum coefficients.

The present invention is designed in view of the aforementioned circumstances, and it is an object thereof to provide a data analysis device, a data analysis method, and a data analysis program capable of speeding up Block Coordinate Descent.

### Means for Solving the Problem

In order to overcome the aforementioned problems and achieve the object, the data analysis device according to the present invention is a data analysis device extracting groups of important features from multidimensional data by using Sparse Group Lasso, and the data analysis device includes: a first computation unit that computes a norm of a Gram matrix of given data; a second computation unit that computes a score for a computation-target group among the groups of the data based on the norm; a determination unit that determines whether or not to omit computation for the computation-target group based on the score computed by the second computation unit; and an application unit that applies, to the computation-target group, computation processing of Block Coordinate Descent used in the Sparse Group Lasso in solving an optimization problem, when the determination unit determines not to omit the computation for the computation-target group.

Furthermore, the data analysis method according to the present invention is a data analysis method executed by a data analysis device that extracts groups of important features from multidimensional data by using Sparse Group Lasso, and the data analysis method includes: a step of computing a norm of a Gram matrix of given data; a step of computing a score for a computation-target group among the groups of the data based on the norm; a step of determining whether or not to omit computation for the computation-target group based on the score; and a step of applying, to the computation-target group, computation processing of Block Coordinate Descent used in the Sparse Group Lasso in solving an optimization problem, when it is determined in the step of determination that the computation for the computation-target group is not omitted.

Furthermore, the data analysis program according to the present invention causes a computer to execute: a step of computing a norm of a Gram matrix of given multidimensional data; a step of computing a score for a computation-target group among groups of the data based on the norm; a step of determining whether or not to omit computation for the computation-target group based on the score; and a step of applying, to the computation-target group, computation processing of Block Coordinate Descent used in Sparse Group Lasso in solving an optimization problem, when it is determined in the step of determination that the computation for the computation-target group is not omitted.

### Effects of the Invention

According to the present invention, it is possible to speed up Block Coordinate Descent.

### BRIEF DESCRIPTION OF DRAWINGS

FIG. 1 is a block diagram illustrating a configuration example of a data analysis device according to an embodiment.

FIG. 2 is a chart illustrating an algorithm used by the data analysis device illustrated in FIG. 1.

FIG. 3 is a flowchart illustrating a processing procedure of data analysis processing according to the embodiment.

FIG. 4 is a diagram illustrating an example of a computer that implements the data analysis device by executing a program.

### DESCRIPTION OF EMBODIMENTS

Hereinafter, an embodiment of the present invention will be described in detail with reference to the accompanying drawings. Note that the present invention is not limited by the embodiment. Furthermore, in the accompanying drawings, same reference signs are applied to same components.

Hereinafter, it is to be noted that when A as a vector, a matrix, or a scaler is written as “^{\hat{ }}A”, it is equivalent to “symbol having “^{\hat{ }}” applied right above “A””. Furthermore, it is to be noted that when A as a vector, a matrix, or a scaler is written as “^{˜}A”, it is equivalent to “symbol having “^{˜}” applied right above “A””. Furthermore, as for A as a vector or a matrix, A^{T} denotes transposition of A.

[Conventional Mathematical Background]

First, as a background knowledge necessary for explanations given hereinafter, Sparse Group Lasso and Block Coordinate Descent will be described.

Since the base of Sparse Group Lasso is a linear regression model, a linear regression problem is looked into. It is to be noted that “n” is the number of data, and each data is expressed with a feature amount of p-dimension. Thereby, data can be expressed with a matrix of X∈R^{n×p}. Linear regression is a problem predicting a response for each data, so that a response can be expressed as vector y∈Rⁿ of the dimensions of the number of data. With linear regression, an inner product of data and a coefficient vector is computed for prediction, so that the coefficient vector is expressed as β∈R^{p}.

Under the above-described setting, Sparse Group Lasso solves optimization problems of the following Expressions (1) and (2) to extract important features and groups of important features.

$$\begin{matrix}[ Math . 1 ] & \\ {min}_{β ∈ {R}^{p}} \frac{1}{2 n} \vert \vert y - {\sum }_{g = 1}^{G} {X}^{( g )} {β}^{( g )} {\vert \vert}_{2} + λΩ ( β ) & ( 1 ) \\ [ Math . 2 ] & \\ Ω ( β ) = ( 1 - α ) {\sum }_{g = 1}^{G} \sqrt{{p}_{g}} {‖ {β}^{( g )} ‖}_{2} + α {‖ β ‖}_{1} & ( 2 )\end{matrix}$$

In Expression (1) and Expression (2), X^{(g)}∈R^{n×pg} is a submatrix of a matrix X, and p_{g} is the size of a feature amount of the g-th group. Similarly, β^{(g)} is a coefficient of the g-th group. G denotes the number of all the groups. Note that α∈[0,1] and λ are hyper parameters, which are targets to be tuned manually.

Block Coordinate Descent is an algorithm for solving the optimization problems of Expression (1) and Expression (2). Specifically, it is an algorithm configured with the following two steps.

The first step is a step that checks whether or not coefficients within a group all become zero. Expressions used for checking in the first step are the following Inequality (3) and Expression (4).

[Math. 3]

∥S(X^{(g)T}r_{(-g)},αλ)∥₂≤\sqrt{p_{g}}(1−α)λ (3).

[Math. 4]

r_{(-g)}=y−Σ_{l≠g}^{G}X^{(l)}β^{(l)} (4)

Note here that a function S(−, −) is computed as in Expression (5) for arguments z, y.

[Math. 5]

S(z,γ)=sign(z[j])(|x[j]|−γ)₊ (5)

When Inequality (3) is satisfied, coefficients of the g-th group all become zero. In that case, the algorithm shifts processing to a next group to perform computation of the first step again. In the meantime, when Inequality (3) is not satisfied, the coefficients are determined as nonzero, and the algorithm executes the following second step.

The second step is a step that updates the coefficients within the group. Update of the coefficients in the second step is executed by using the following Expression (6) and Expression (7). In Expression (6) and Expression (7), t is an update width.

$$\begin{matrix}[ Math . 6 ] & \\ {β}_{new}^{( g )} = {( 1 - t ( 1 - α ) λ / {‖ S ( {Z}^{( g )} , t αλ ) ‖}_{2} )}_{+} S ( {Z}^{( g )} , t αλ ) & ( 6 ) \\ [ Math . 7 ] & \\ {Z}^{( g )} = {β}^{( g )} + \frac{t}{n} ( {X}^{( g ) T} {r}_{( - g )} - {X}^{( g ) T} {X}^{( g )} {β}^{( g )} ) & ( 7 )\end{matrix}$$

The algorithm repeats the first step and the second step until the entire coefficients converge. With this algorithm, O(pp_{g}+p_{g}²) is necessary for the computation of the first step, and O(p_{g}) is necessary for the computation of the second step. Thus, with Block Coordinate Descent, the first step is the bottleneck.

[Mathematical Background of Embodiment]

Subsequently, the mathematical background of the embodiment will be described. In the embodiment, Block Coordinate Descent is sped up by reducing the computation amount of the first step that is the bottleneck of Block Coordinate Descent.

Specifically, in the embodiment, the computation amount is reduced by approximating Inequality (3) used in the first step. This approximation is implemented by checking whether or not the inequality is satisfied by using an upper limit value U^{(g)} of the term ∥S(X^{(g)T}γ_{(-g)}, αλ∥ in Inequality (3). That is, in the first step, U^{(g)} satisfying Inequality (8) is used as an approximate value, and Inequality (9) is checked instead of Inequality (3) requiring a large computation amount.

[Math. 8]

∥S(X^{(g)T}r_{(-g)},αλ)∥₂≤U^{(g)} (8)

[Math. 9])

U^{(g)}≤\sqrt{p_{g}}(1−α)λ (9)

U^{(g)} is computed as in the following Expression (10) and Expression (11), assuming that a Gram matrix of data is K=X^{T}X∈R^{p×p}.

[Math. 10]

U^{(g)}=∥X^{(g)T}\tilde{r}_{(-g)}∥₂+Λ(g,g)+Σₗ₌₁^{G}Λ(g,l) (10)

[Math. 11]

Λ(g,l)=∥\hat{K}^{(g)}[l]∥₂∥β^{(l)}−\tilde{β}^{(l)}∥₂ (11)

In Expression (10) and Expression (11), ^{˜}γ_{(-g)} and ^{˜}β^{(l)} are values corresponding to γ_{(-g)} and β^{(l)}, respectively. Those values are updated in a specific interval in an iteration of Block Coordinate Descent.

Assuming that K^{(g,l)}∈R^{pg×pl} is a submatrix of K, the i-th element of \hat{ }K^{(g)} [l]∈R^{pg} is computed as L2norm∥K^{(g,l)} [i;]∥₂ on the i-th row thereof.

As for the initial value of the upper limit value of Expression (10), computation is performed as formulated. However, thereafter, computation of the following Expression (12) is performed only when β^{(g)} is updated. As a result, in the embodiment, it is possible to update the upper limit value with a small computation amount.

[Math. 12]

U_{new}^{(g)}=U^{(g)}−2Λ(g,g)+2∥\hat{K}^{(g)}[g]∥₂∥β^{(g)′}−\tilde{β}^{(g)}∥₂ (12)

β^{(g)}′ is the updated β^{(g)}. Thereby, while Expression (3) of the original Block Coordinate Descent requires the computation amount of O(pp_{g}+p_{g}²), the computation amount of Inequality (9) becomes sufficiently small as O(p_{g}). Therefore, in the embodiment, it is possible to perform approximate computation at a high speed for the computation of the first step that is the bottleneck of the conventional algorithm.

When Inequality (9) is satisfied, coefficients of the group g all become zero. In that case, a relation of ∥S(X^{(g)T}γ_{(-g)}, αλ∥≤U^{(g)} is satisfied, so that the coefficients can be made zero securely without mistakenly making the coefficients zero. In the meantime, when Inequality (9) is not satisfied, the first step and the second step of the normal Block Coordinate Descent are executed.

As described above, in the embodiment, the coefficients are not mistakenly made zero. Thus, when the initial values of the coefficients and the update order are the same, a same solution as that of the original Block Coordinate Descent can be acquired.

### Embodiment

Thus, a data analysis device will be described in the embodiment. The data analysis device according to the embodiment is a learning device of a linear regression model that extracts groups of important features from multidimensional data by using Sparse Group Lasso.

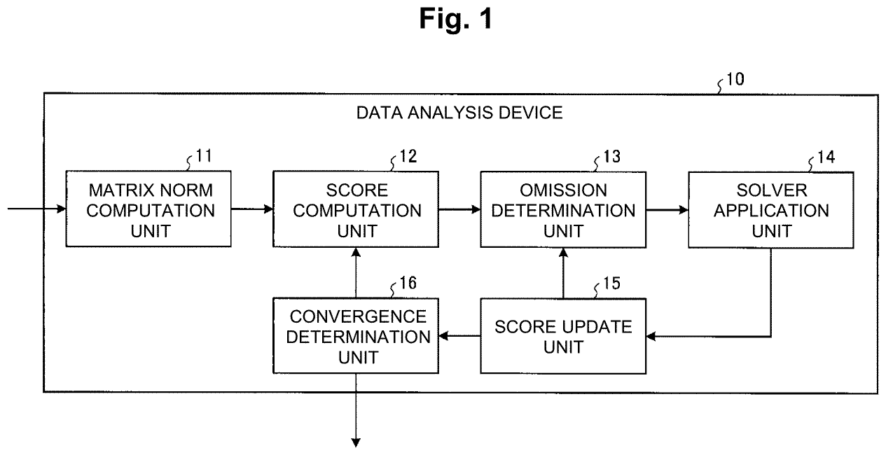

FIG. 1 is a block diagram illustrating a configuration example of the data analysis device according to the embodiment. As illustrated in FIG. 1, a data analysis device 10 according to the embodiment includes a matrix norm computation unit 11 (a first computation unit), a score computation unit 12 (a second computation unit), an omission determination unit 13 (a determination unit), a solver application unit 14 (an application unit), a score update unit 15, and a convergence determination unit 16. The data analysis device 10 is implemented by loading a prescribed program into a computer or the like including a ROM (Read Only Memory), RAM (Random Access Memory), a CPU (Central Processing Unit), and the like, and executing the prescribed program by the CPU, for example.

The matrix norm computation unit 11 computes a norm of a Gram matrix of given data. In the embodiment, it is necessary to compute the upper limit value U^{(g)} based on Expression (10) and Expression (11). Note here that ∥\hat{ }K^{(g)}[l]∥₂ of Expression (11) can be pre-computed at the point where the data is given, and it is not changed in the algorithm. The matrix norm computation unit 11 has a function of computing ∥\hat{ }K^{(g)}[l]∥₂. ∥\hat{ }K^{(g)}[l]∥₂ is the norm of the Gram matrix K as described above.

The score computation unit 12 computes a score for a computation-target group among the groups of the data based on the norm computed by the matrix norm computation unit 11. The score is a value used for determining whether or not to omit computation of the computation-target group. The score computation unit 12 computes the upper limit value U^{(g)} expressed by Expression (10) for all the groups. In the embodiment, the score is defined as the upper limit value U^{(g)}. That is, the score is the upper limit value U^{(g)} itself when the term ∥S(X^{(g)T}γ_{(-g)}, αλ∥ in Inequality (3) is approximated.

The omission determination unit 13 determines whether or not to omit computation of the computation-target group based on the score computed by the score computation unit 12. The omission determination unit 13 determines whether or not Inequality (9) is satisfied by using the score (the upper limit value U^{(g)}) acquired by the score computation unit 12. In the computation processing of Block Coordinate Descent, the omission determination unit 13 performs evaluation by using an approximate expression (Inequality (9)) in which the term in Inequality (3) used when checking whether or not the coefficients in the group all become zero is approximated with the upper limit value U^{(g)} of the term. When Inequality (9) is satisfied, the omission determination unit 13 sets all of the coefficients in the group to “0”. Therefore, when Inequality (9) is satisfied, the omission determination unit 13 determines to omit computation processing of the normal Block Coordinate Descent (solver) for that group.

When the convergence determination unit 13 determines not to omit the computation for the computation-target group, the solver application unit 14 executes the computation processing of the normal Block Coordinate Descent (solver). That is, when Inequality (9) is not satisfied, the solver application unit 14 executes the computation processing of the solver. In other words, the solver application unit 14 performs the first step that checks whether or not the coefficients in the group all become zero by using Inequality (3). When Inequality (3) is satisfied, the solver application unit 14 sets all of the coefficients of the group to “0”. In the meantime, when Inequality (3) is not satisfied, the solver application unit 14 executes the second step that updates the coefficients within the group by using Expression (6) and Expression (7).

The score update unit 15 updates the score for the computation-target group. When the coefficients are updated by the solver application unit 14, the score update unit 15 updates the score (the upper limit value U^{(g)}) for the group by using Expression (12). The data analysis device 10 applies processing by the omission computation unit 13 for all the groups, and applies the computation processing by the solver application unit 14 when Inequality (9) is not satisfied.

After applying the processing by the omission computation unit 13 to all the groups and applying the computation processing by the solver application unit 14 when Inequality (9) is not satisfied, the convergence determination unit 16 determines whether or not the coefficients have converged. When the coefficients have converged, the convergence determination unit 16 returns the converged coefficients. When the coefficients have not converged, the convergence determination unit 16 returns to the processing by the score computation unit 12 and repeats the processing until the convergence is completed.

[Flow of Processing]

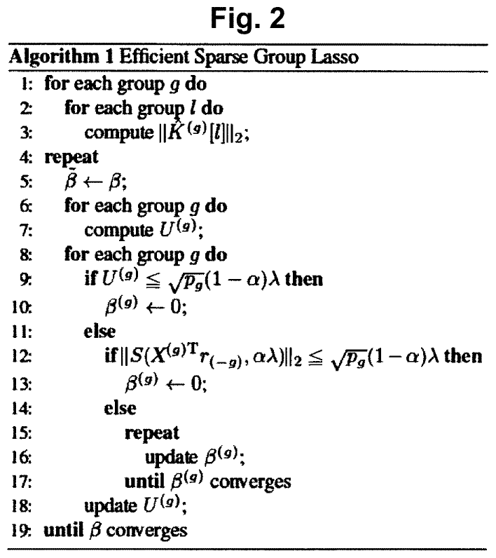

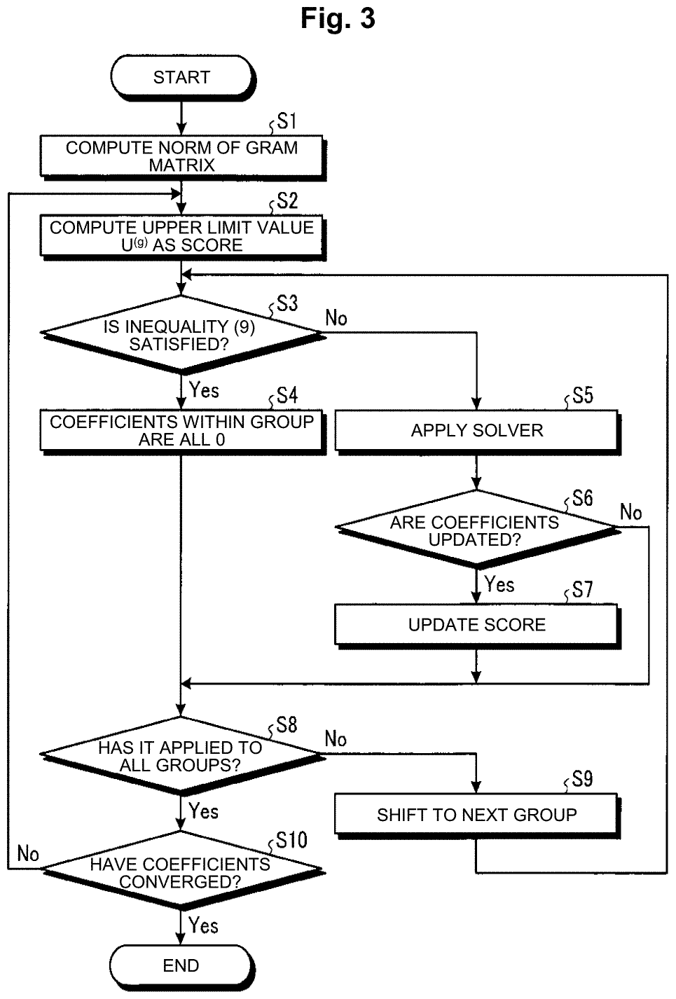

Next, an algorithm used by the data analysis device 10 and a flow of the processing executed by the data analysis device 10 will be described. FIG. 2 is a chart illustrating the algorithm used by the data analysis device 10 illustrated in FIG. 1. FIG. 3 is a flowchart illustrating a processing procedure of a data analysis method according to the embodiment.

As in the algorithm of FIG. 2 and the flowchart of FIG. 3, the matrix norm computation unit 11 computes the norm of the Gram matrix of the given data (first to third lines of FIG. 2 and step S1 of FIG. 3).

Subsequently, the score computation unit 12 computes, for all the groups, the upper limit value U^{(g)} expressed by Expression (10) as the scores for the groups by using Expression (10) and Expression (11) (fifth to seventh lines of FIG. 2 and step S2 of FIG. 3).

The omission determination unit 13 determines whether or not to omit the computation of the group based on the score. Specifically, the omission determination unit 13 determines whether or not Inequality (9) is satisfied by using the score (upper limit value U^{(g)}) acquired by the score computation unit 12 (step S3 of FIG. 3).

Then, when determined that Inequality (9) is satisfied (ninth line of FIG. 2 and Yes at step S3 of FIG. 3), the omission determination unit 13 sets all of the coefficients in the group to “0” (tenth line of FIG. 2 and step S4 of FIG. 3).

In the meantime, when the omission determination unit 13 determines that Inequality (9) is not satisfied (twelfth line of FIG. 2 and No at step S3 of FIG. 3), the solver application unit 14 executes the computation processing of the normal Block Coordinate Descent (solver) (twelfth to seventeenth lines of FIG. 2 and step S5 of FIG. 3). Specifically, the solver application unit 14 performs the first step that checks whether or not the coefficients in the group all become zero by using Inequality (3) and, when Inequality (3) is satisfied (twelfth line of FIG. 2), sets all of the coefficients of the group to “0” (thirteenth line of FIG. 2). In the meantime, when Inequality (3) is not satisfied (fourteenth line of FIG. 2), the solver application unit 14 executes the second step that updates the coefficients in the group by using Expression (6) and Expression (7) (fifteenth to seventeenth lines of FIG. 2).

Then, when the coefficients are updated by the solver application unit 14 (Yes at step S6), the score update unit 15 updates the score (upper limit value (U^{(g)}) for the group by using Expression (12) (eighteenth line of FIG. 2 and step S7 of FIG. 3).

When step S3 to step S7 have not been applied to all the groups (No at step S8 of FIG. 3), the data analysis device 10 shifts to a next group (step S9) and executes the processing of step S3 and thereafter. Furthermore, when step S3 to step S7 have been applied to all the groups (eighth to eighteenth lines of FIG. 2 and Yes at step S8 of FIG. 3), the convergence determination unit 16 determines whether or not the coefficients have converged (nineteenth line of FIG. 2 and step S10 of FIG. 3).

When determined that the coefficients have converged (Yes at step S10 of FIG. 3), the convergence determination unit 16 returns the converged coefficients and ends the processing. When determined that the coefficients have not converged (No at step S10 of FIG. 3), the convergence determination unit 16 returns to the processing of step S2, and repeats the processing of step S2 to S10 until the convergence is completed.

### Effects of Embodiment

As described, the data analysis device 10 according to the embodiment is a learning device of a linear regression model that extracts groups of important features from multidimensional data by using Sparse Group Lasso. Furthermore, the data analysis device 10 computes the norm of the Gram matrix of the given data, and computes the score for the computation-target group among the groups of the data. Subsequently, the data analysis device 10 determines whether or not to omit computation for the computation-target group based on the score.

Then, when determined not to omit the computation for the computation-target group, the data analysis device 10 applies, to the computation-target group, the computation processing of Block Coordinate Descent that is used in Sparse Group Lasso in solving an optimization problem. Therefore, the data analysis device 10 is capable of speeding up Block Coordinate Descent since the computation of Block Coordinate Descent is not applied to all of the groups.

At this time, in the computation processing of Block Coordinate Descent, the data analysis device 10 performs evaluation by using an approximate expression in which the term in the inequality used when checking whether or not the coefficients in the group all become zero is approximated with the upper limit value of the term. In other words, the data analysis device 10 replaces the inequality used when checking whether or not the coefficients in the group all become zero with the approximate expression of still smaller computation amount. Therefore, the data analysis device 10 is capable of lightening the computation of the first step that determines whether the coefficients of the group are zero or nonzero, which is the bottleneck of Block Coordinate Descent using Inequality (3), so that it is possible to speed up Block Coordinate Descent.

As a result, with the embodiment, Block Coordinate Descent is sped up so that feature group extraction processing by Sparse Group Lasso can be sped up. Furthermore, while the approximation described above is employed to speed up Block Coordinate Descent in the embodiment, it is guaranteed that the learning result thereof matches that of the original Block Coordinate Descent. Therefore, with the embodiment, it is possible to accurately extract the feature group by Sparse Group Lasso.

[Configuration of System of Embodiment]

Each of the structural elements of the data analysis device 10 illustrated in FIG. 1 is of functional concept, and not necessarily need to be configured as illustrated physically. That is, the specific form of distribution and integration of the functions of the data analysis device 10 is not limited to that illustrated in the drawing, and it is possible to functionally or physically distribute or integrate the whole part or a part thereof in an arbitrary unit according to various kinds of load, use state, and the like.

Furthermore, the whole part or an arbitrary part of each processing executed in the data analysis device 10 may be implemented by the CPU and a program analyzed and executed by the CPU. Furthermore, each processing executed in the data analysis device 10 may be implemented as hardware with a wired logic.

Furthermore, in processing described in the embodiment, the whole part or a part of the processing described to be performed automatically may be performed manually. Alternatively, the whole part or a part of the processing described to be performed manually may be performed automatically by a publicly known method. In addition, the above-described and illustrated processing procedure, control procedure, specific names, and information including various kinds of data and parameters may be changed as appropriate unless otherwise noted.

[Program]

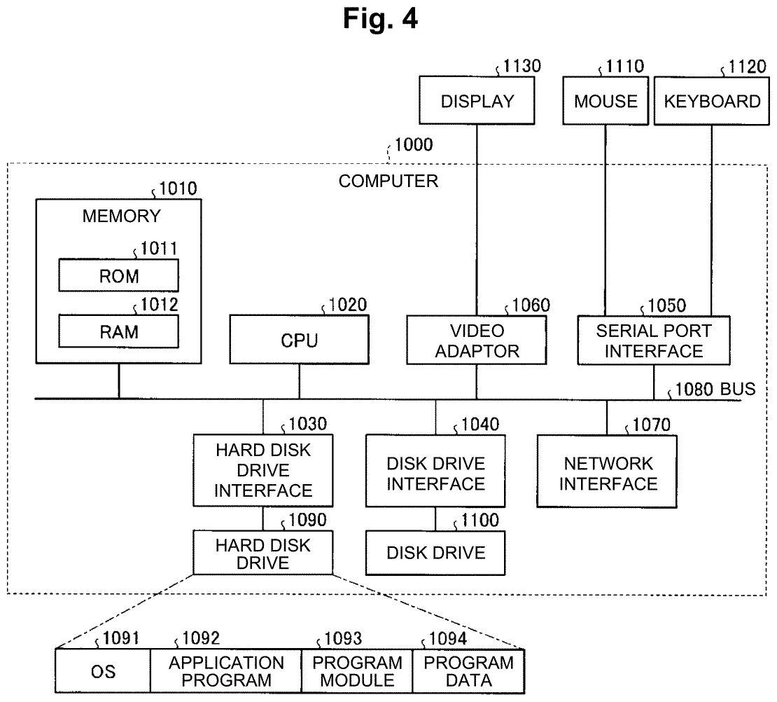

FIG. 4 is a diagram illustrating an example of a computer that implements the data analysis device 10 by executing a program. A computer 1000 includes a memory 1010 and a CPU 1020, for example. Furthermore, the computer 1000 includes a hard disk drive interface 1030, a disk drive interface 1040, a serial port interface 1050, a video adaptor 1060, and a network interface 1070. Those units are each connected via a bus 1080.

The memory 1010 includes a ROM 1011 and a RAM 1012. The ROM 1011 stores a boot program such as BIOS (Basic Input Output System), for example. The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adaptor 1060 is connected to a display 1130, for example.

The hard disk drive 1090 stores an OS 1091, an application program 1092, a program module 1093, and program data 1094, for example. That is, the program defining each processing of the data analysis device 10 is mounted as the program module 1093 in which codes that can be executed by the computer 1000 are written. The program module 1093 is stored in the hard disk drive 1090, for example. For example, the program module 1093 for executing the processing same as the functional configuration of the data analysis device 10 is stored in the hard disk drive 1090. Note that the hard disk drive 1090 may be replaced with an SSD (Solid State Drive).

Furthermore, setting data used in the processing of the embodiment described above is stored as the program data 1094 in the memory 1010 or the hard disk drive 1090, for example. Then, the CPU 1020 loads the program module 1093 and the program data 1094 stored in the memory 1010 or the hard disk drive 1090 to the RAM 1012, and executes them as necessary.

Note that the program module 1093 and the program data 1094 are not limited to be stored in the hard disk drive 1090 but may be stored in a removable storage medium, for example, and read out by the CPU 1020 via the disk drive 1100 or the like. Alternatively, the program module 1093 and the program data 1094 may be stored in another computer connected via a network (LAN (Local Area Network), WAN (Wide Area network) or the like). Furthermore, the program module 1093 and the program data 1094 may be read out by the CPU 1020 from the other computer via the network interface 1070.

While the embodiment to which the present invention invented by the inventors thereof is applied has been described above, the present invention is not limited by the description and the drawings forming a part of the disclosure of the present invention according to the embodiment. That is, other embodiments, examples, operational techniques, and the like occurred to those skilled in the art based on the embodiment are all included within the scope of the present invention.

### REFERENCE SIGNS LIST

10 Data analysis device
11 Matrix norm computation unit
12 Score computation unit
13 Omission determination unit
14 Solver application unit
15 Score update unit
16 Convergence determination unit

1. A data analysis device extracting groups of important features from multidimensional data by using Sparse Group Lasso, the data analysis device comprising:
first computation circuitry that computes a norm of a Gram matrix of given data;
second computation circuitry that computes a score for a computation-target group among the groups of the data based on the norm;
determination circuitry that determines whether or not to omit computation for the computation-target group based on the score computed by the second computation circuitry; and
application circuitry that applies, to the computation-target group, computation processing of Block Coordinate Descent used in the Sparse Group Lasso in solving an optimization problem, when the determination circuitry determines not to omit the computation for the computation-target group.

2. The data analysis device according to claim 1, wherein, in the computation processing of the Block Coordinate Descent, the determination circuitry performs evaluation by using an approximate expression in which a term in an inequality used when checking whether or not coefficients in the group all become zero is approximated with an upper limit value of the term.

3. A data analysis method executed by a data analysis device that extracts groups of important features from multidimensional data by using Sparse Group Lasso, the data analysis method comprising:
computing a norm of a Gram matrix of given multidimensional data;
computing a score for a computation-target group among groups of the multidimensional data based on the norm;
determining whether or not to omit computation for the computation-target group based on the score; and
applying, to the computation-target group, computation processing of Block Coordinate Descent used in Sparse Group Lasso in solving an optimization problem, when it is determined in the determining that the computation for the computation-target group is not omitted.

4. A computer readable non-transitory recording medium including a data analysis program causing a computer to execute:
computing a norm of a Gram matrix of given multidimensional data;
computing a score for a computation-target group among groups of the multidimensional data based on the norm;
determining whether or not to omit computation for the computation-target group based on the score; and
applying, to the computation-target group, computation processing of Block Coordinate Descent used in Sparse Group Lasso in solving an optimization problem, when it is determined in the determining that the computation for the computation-target group is not omitted.
